(19) United States
(12) Patent Application Publication
(10) Pub. No.: US 2006/0110224 A1
(43) Pub. Date: May 25, 2006

(54) Soil drainage system

(76) Inventor: Dirk Albertus Bodegom, VJ Bergambacht (NL)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 10/537,759

(22) PCT Filed: Dec. 5, 2003
(86) PCT No.: PCT/NL03/00864

§ 371 Date: Jan. 17, 2006

(30) Foreign Application Priority Data
Dec. 5, 2002 (NL) 1022086

(51) Int. Cl. C09K 17/00; E02D 3/00

(52) U.S. Cl. 405/302.4; 405/258.1; 405/271

(57) ABSTRACT

System for withdrawing liquid, in particular water, from a soil area, such as for consolidating it, comprising a series of spaced apart draining means extending downwardly, in particular substantially vertically, in the soil and a substantially horizontally extending drainage line, which is arranged in the soil for receipt of the soil fluid passed through the downwardly extending drainage means and which in a transitional area in a border area of the soil area to be treated, such as to be consolidated, changes into a pump line which leads to a pump positioned outside of the oil area to be treated, an oversize of line length being provided in the transitional area prior to making the system operational.

The invention relates to a system for withdrawing a liquid, in particular water, from a soil.

It is known to consolidate a soil area by introducing drainage ribbons vertically into the soil, at a horizontal distance from each other, and connecting the upper ends of said drainage ribbons to a horizontal drainage pipe, which has been arranged in a trench in the soil, at a distance below the ground level. At one end the drainage pipe is coupled to a pump line, which extends in a curved manner through the soil, adjacent to the soil area to be consolidated, to a well pump placed at ground level. The drainage pipe is put on a vacuum by the pump, so that water rising in the vertical drainage ribbons is sucked into the drainage pipe and to the pump. This vacuum is increased using a system as disclosed in International patent application WO 02/29164, the contents of which are considered to be incorporated here.

The soil area will settle due to the withdrawal of water from said soil area.

As a result of the settlement the soil area to be consolidated will be lowered with respect to the adjacent areas. The drainage pipe will come to lie lower than in the initial situation, but this does not apply to the pump, which remains at its original level. The distance between the pump and the part or end of the drainage pipe at the border or edge area of the soil area to be consolidated is increased. Due to the clamping as a result of soil pressure on the pump line accommodated in the soil, said increase in length cannot usually be provided by increasing the bending radius of the pump line.

Thus the pump line may be subjected to large tensile stresses, which may as a result collapse due to which the drainage stops. The pump line will have to be dug up and replaced.

It has been tried before to find a solution to this problem by using a pump line having a ribbed wall, which can be stretched due to the ribs. However, the vacuum applied for withdrawing water from the layer of soil counteracts the expansion of such ribbed hoses. In addition, in view of the required deformability of such ribbed hoses, these hoses would tend to buckle in inner curves of bent portions under the influence of the vacuum applied. In addition it may be that the soil penetrates between the ribs and impedes the elongation to a large extent, as a result of which large tensile stresses may still arise in the pump line.

It is an object of the invention to improve on this.

It is a further object of the invention to provide a reliable functioning system for withdrawing water from a soil area for consilidating the soil area.

It is a further object of the invention to provide a reliable functioning system for withdrawing water from a soil area for withdrawing substances from that soil area. These substances can be pollutants or minerals.

It is a further object of the invention to provide a system of the type mentioned in the preamble, which can be operative for a long time, also after advanced settlement.

From one aspect the invention to that end provides a system for withdrawing water from a soil area, such as for consolidating it, comprising a series of spaced apart draining means extending downwardly, in particular substantially vertically in the soil and a substantially horizontally extending drainage line, which is arranged in the soil for receipt of the soil fluid passed through the downwardly extending drainage means and which in a transitional area in a border area of the soil area to be treated, such as to be consolidated, changes into a pump line which leads to a pump positioned outside of the soil area to be treated, an oversize of line length being provided in the transitional area prior to making the system operational.

As a result a length surplus is provided for the line in the dilatation area itself, as a result of which the line parts connecting on either side can remain free from tensile stresses.

Preferably the oversize has a length which at a minimum is adjusted to the expected settlement, so that also towards the end of the treatment, such as consolidation process tensile stresses are prevented. A safety margin can be observed here.

Preferably the transitional area is situated near the outermost downwardly extending drainage means, where the derivative of the settlement curve is largest.

In a reliable embodiment the oversize is designed as a slide connection with an overlap between two line ends that are inserted into each other. As a result the oversize is as it were present in a concealed manner, and free from activity of the soil thereon.

In a further embodiment hereof, the line ends are formed by a discharge end of the drainage line and a receiving end of the pump line, which at the location of the slide connection can be slid into each other and form an overlap at that location. The connection between both lines is thus utilised for forming the oversize.

Preferably the receiving end of the pump line is slidably accommodated in the discharge end of the drainage line. The drainage line will usually have a larger diameter than the pump line and thus be able to provide sufficient room for the overlap. The end of the drainage line can smoothly follow the settling movement of the soil area which is treated.

In an embodiment the slide connection comprises a sleeve part and a clamping part for securing the discharge end of the drainage line to the sleeve part by clamping about it, the sleeve part slidably holding the receiving end of the pump line.

In order to prevent leakage from the line a sealing is preferably arranged between the sleeve part and the receiving end of the pump line.

In order to prevent that the pump line is sucked into the drainage line as a result of the vacuum, the slide connection can be provided with a limiter which is active in the direction of mutual approach of the discharge end of the drainage line and the receiving end of the pump line.

For facilitating the fitting of the system, the discharge end can be detachably attached to the end of a drainage pipe, such as by means of a snap connection.

Preferably, the downwardly extending drainage means are elongated and spaced from each other. The downwardly extending drainage means may be formed by drainage strips/ribbons.

Preferably, the horizontal extending drainage line is covered by an air sealing layer.

From a further aspect the invention provides an assembly for withdrawing water from a soil area for consolidating it, comprising a number of systems according to the invention, which each are connected to a central pump with their own pump line.

From yet another aspect the invention provides an assembly for withdrawing water from a soil area for removing substances, such as minerals, such as gold, from the soil area, comprising a number of systems according to the invention, which each are connected to a central pump with their own pump line.

The invention will be elucidated on the basis of an exemplary embodiment shown in the attached drawings, in which:

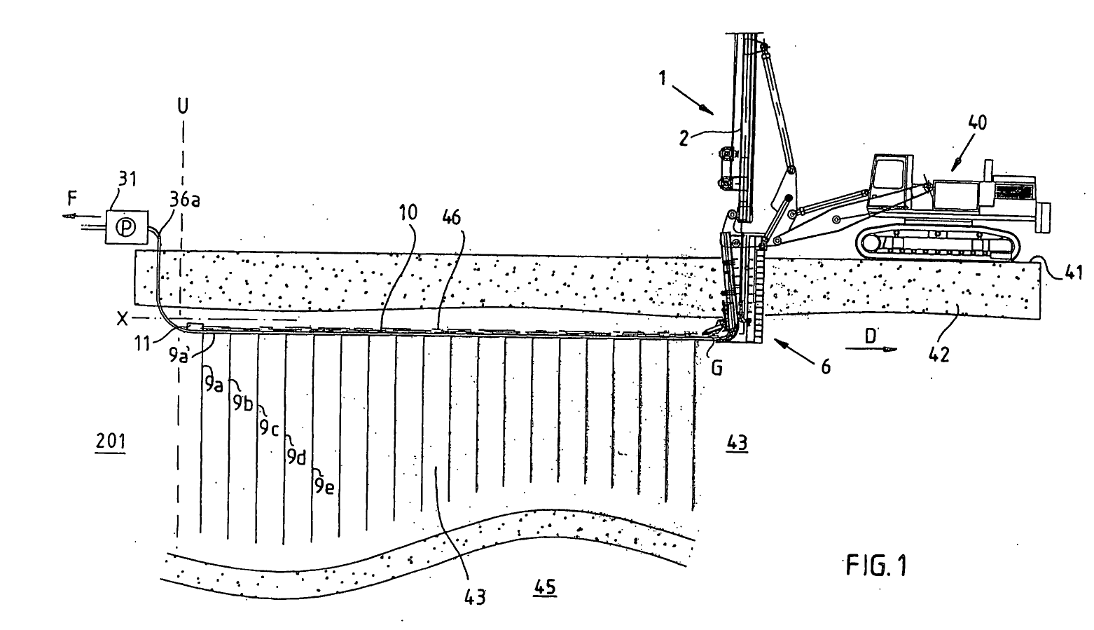

FIG. 1 schematically shows an arrangement according to the invention during installation;

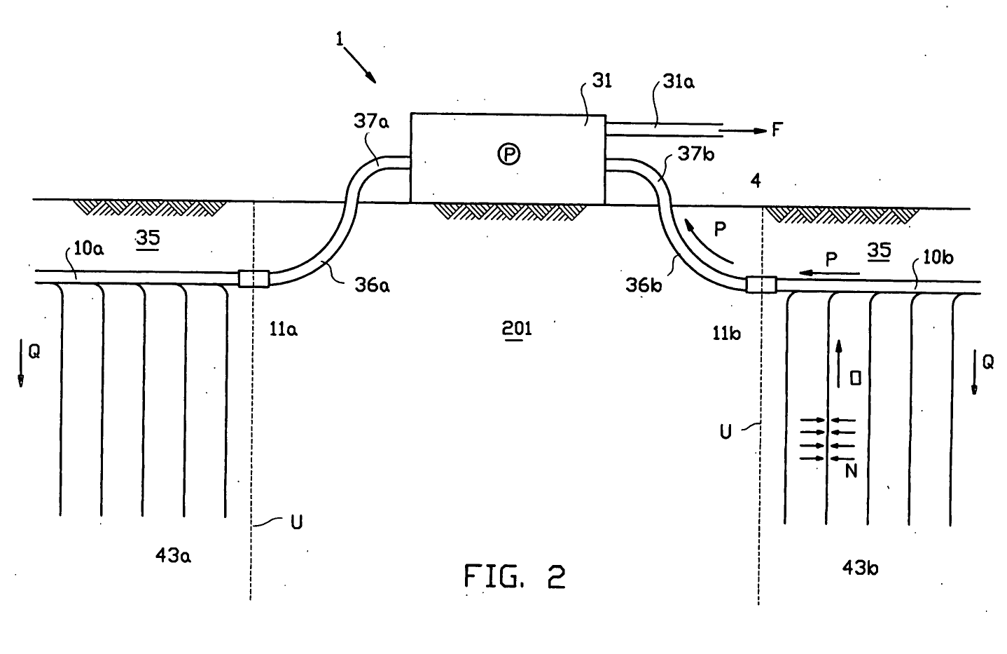

FIG. 2 shows a schematic view of an assembly having several systems according to an exemplary embodiment of the invention;

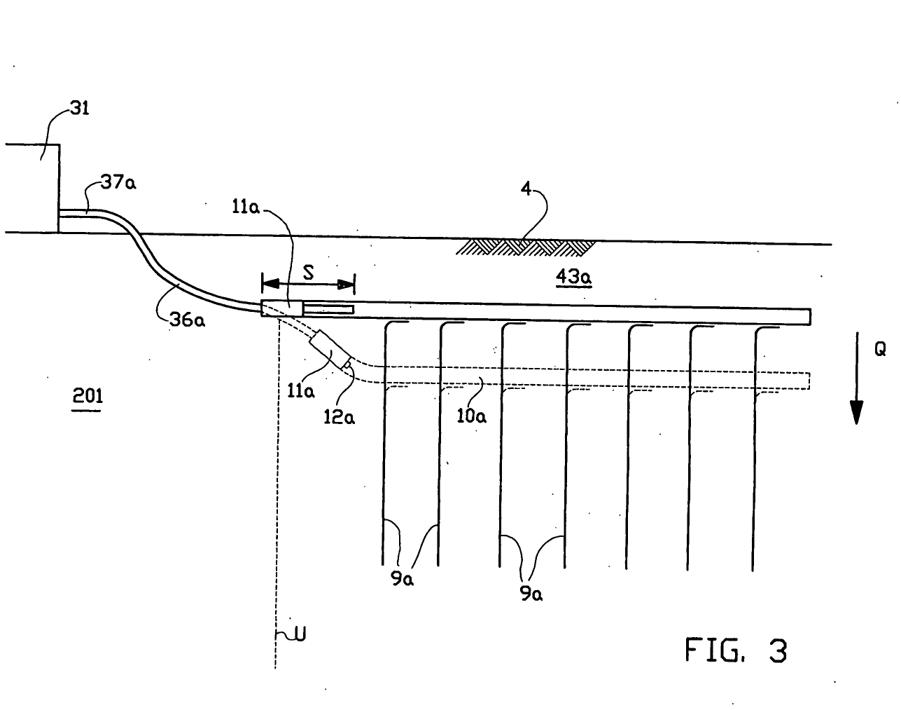

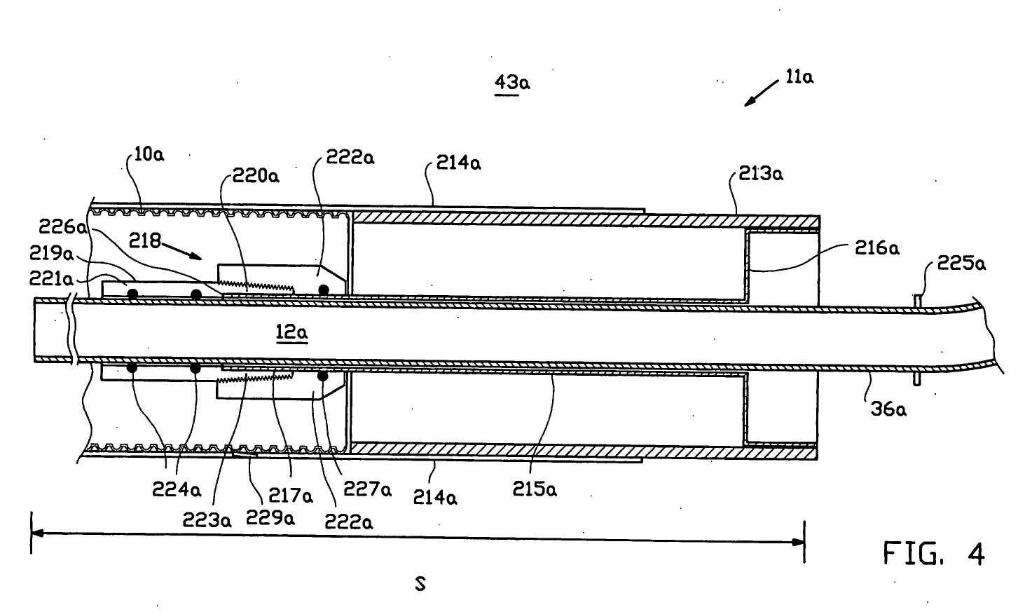

FIG. 3 shows a further view of a system according to the invention, in an initial situation and in a situation after having been used for some time;

FIG. 4 shows a detail of a transitional structure in the system of FIG. 3;

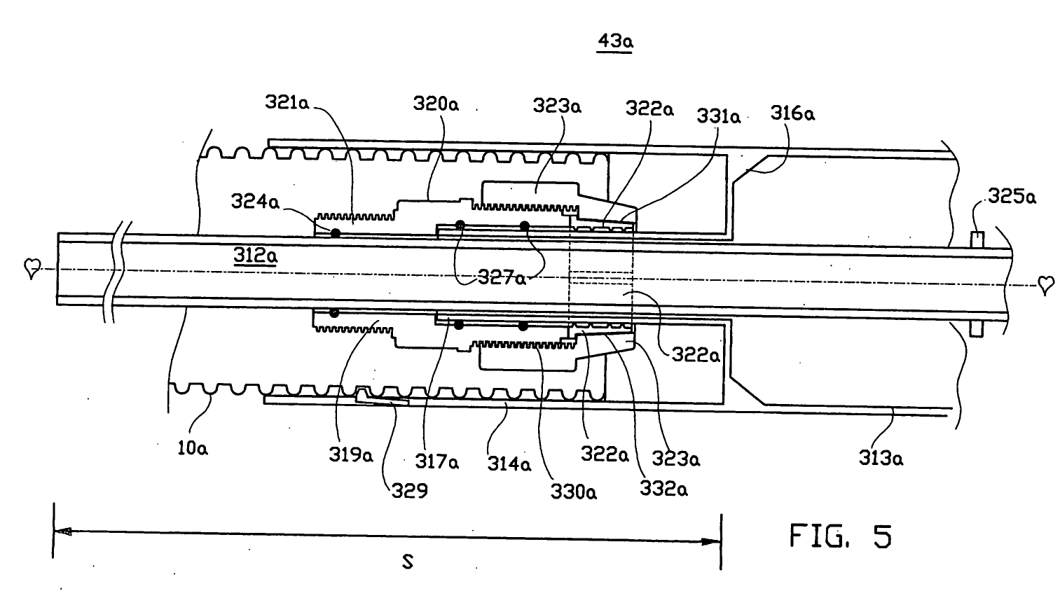

FIG. 5 shows a detail of an alternative transitional structure for the system of FIG. 3;

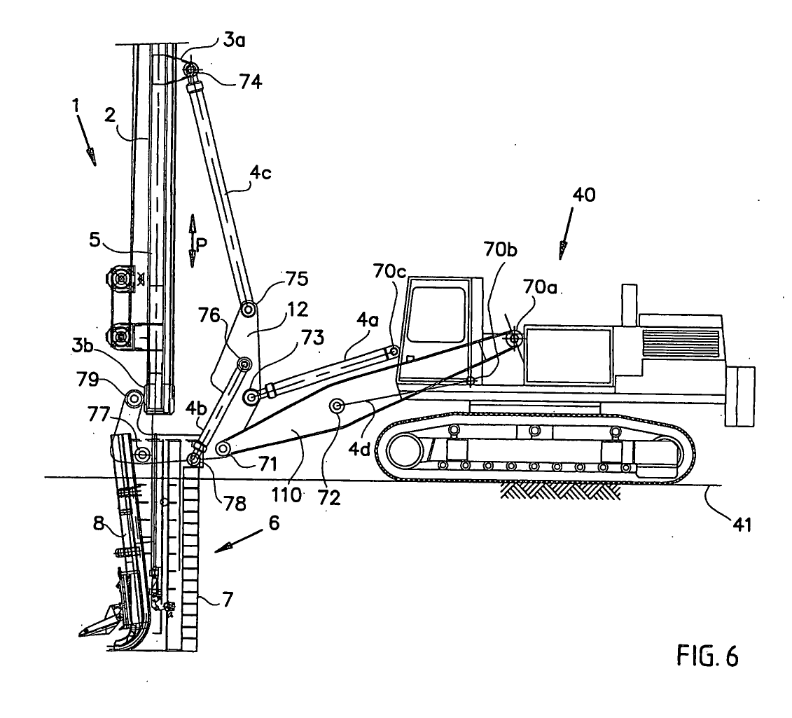

FIG. 6 is an example of a partial arrangement for an apparatus for use in the installation, extending to below the ground level;

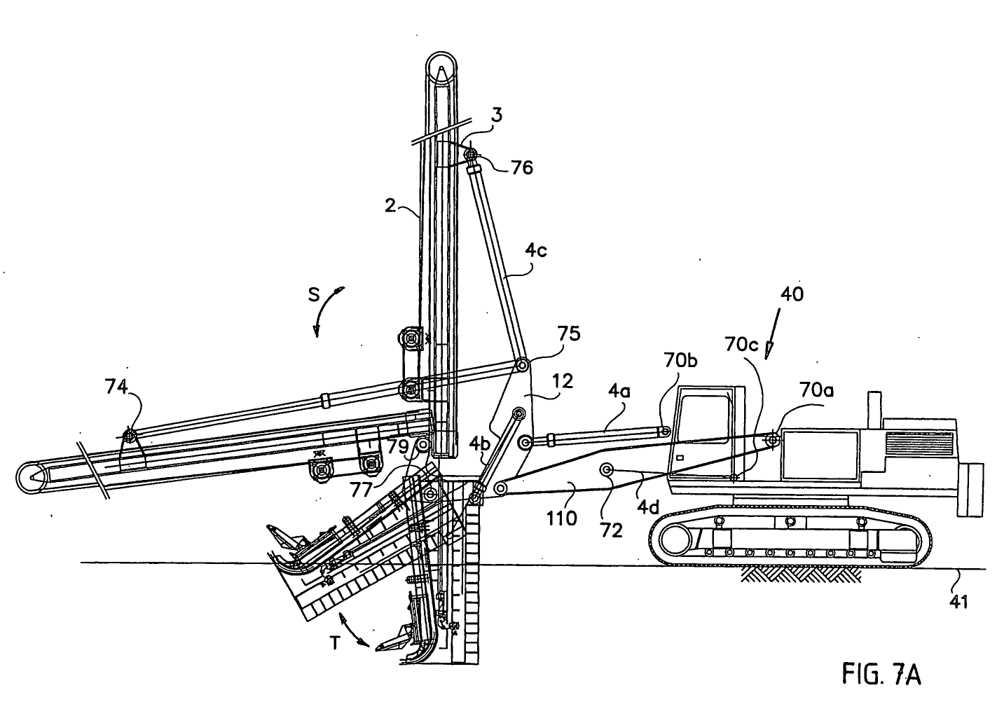

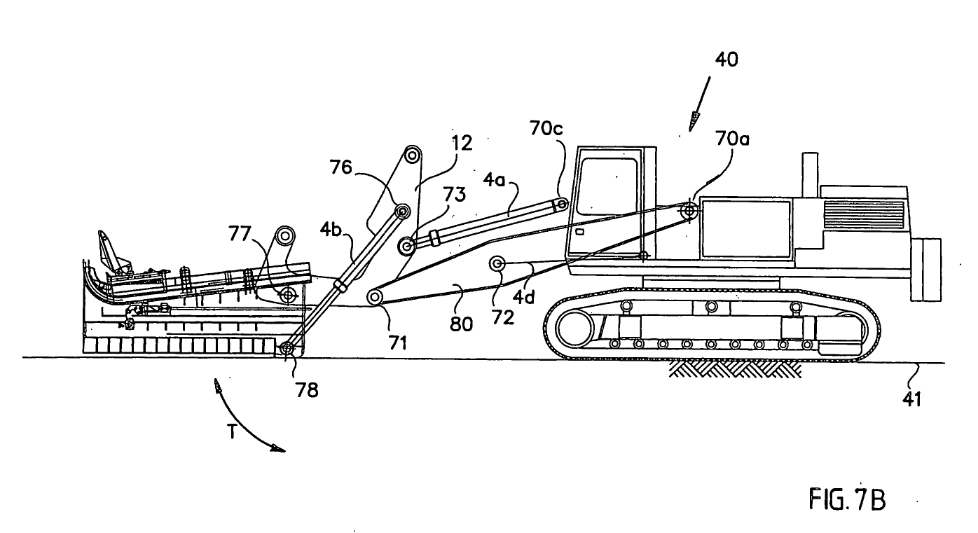

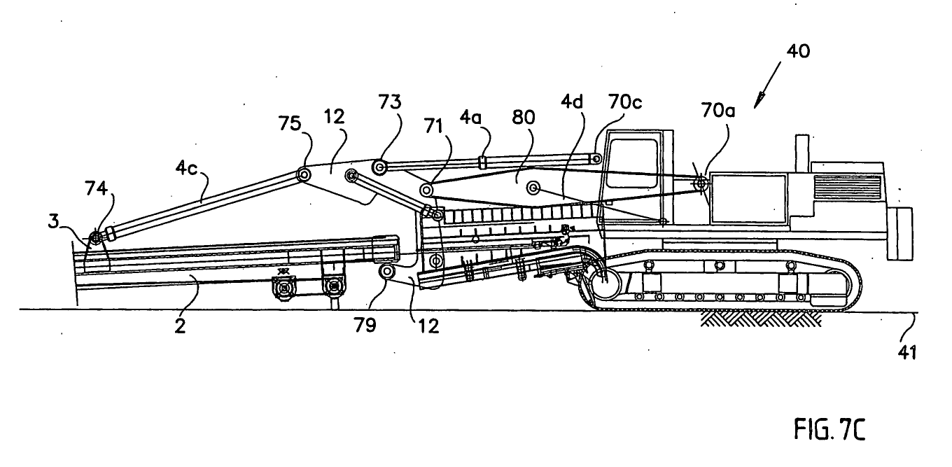

FIGS. 7A-C show several possible states of the apparatus according to FIG. 6, amongst others a fully collapsed state (FIG. 7C);

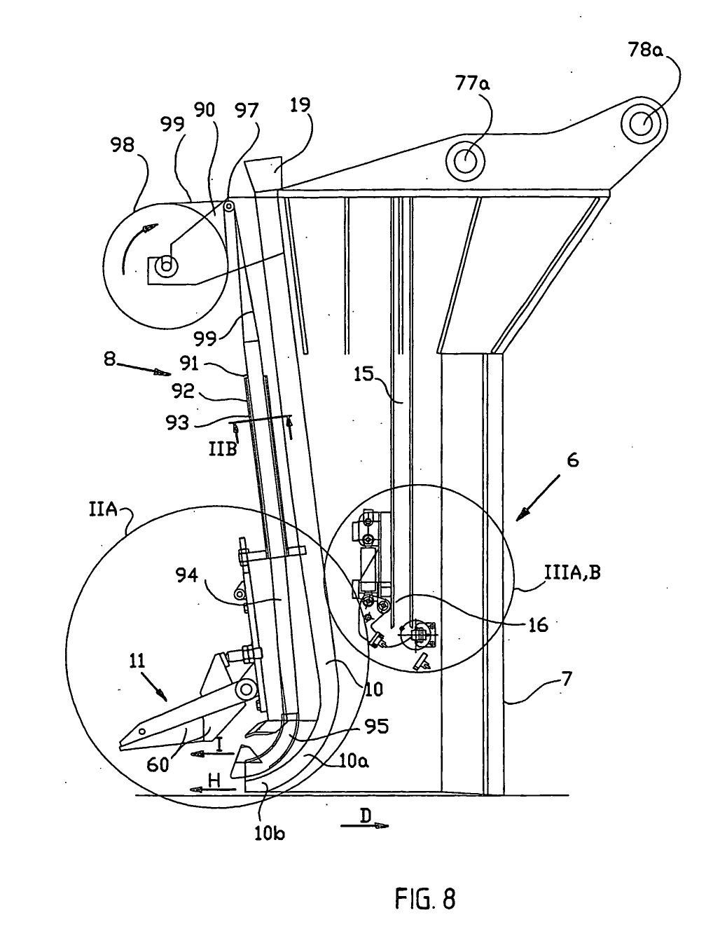

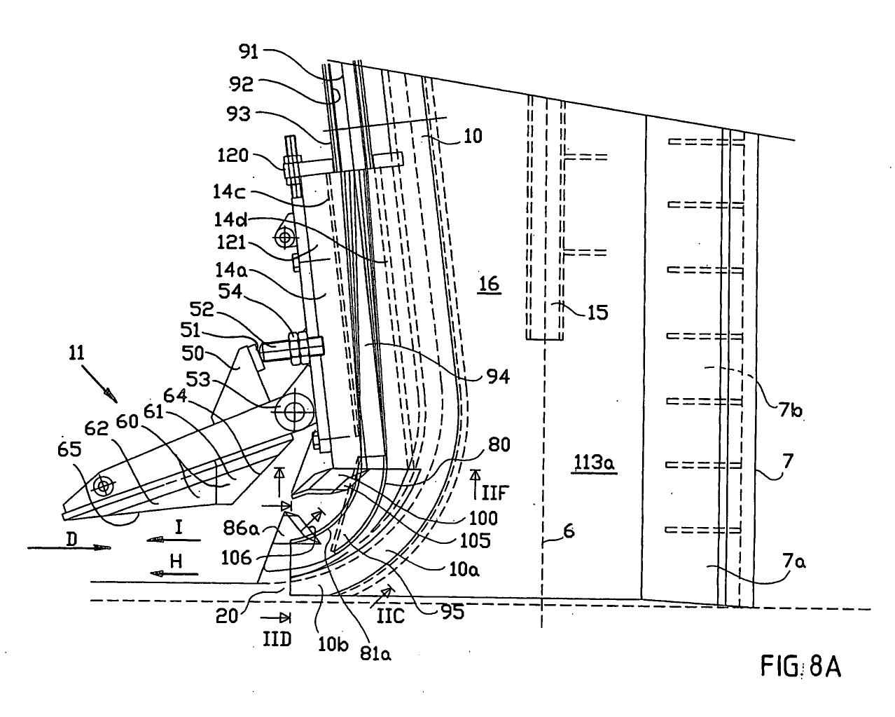

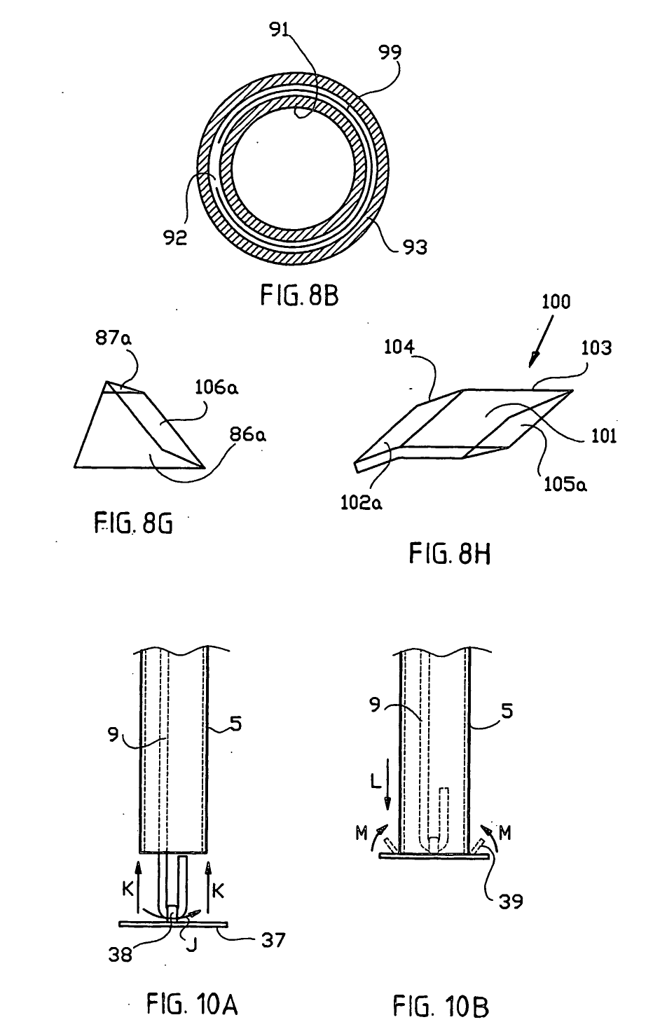

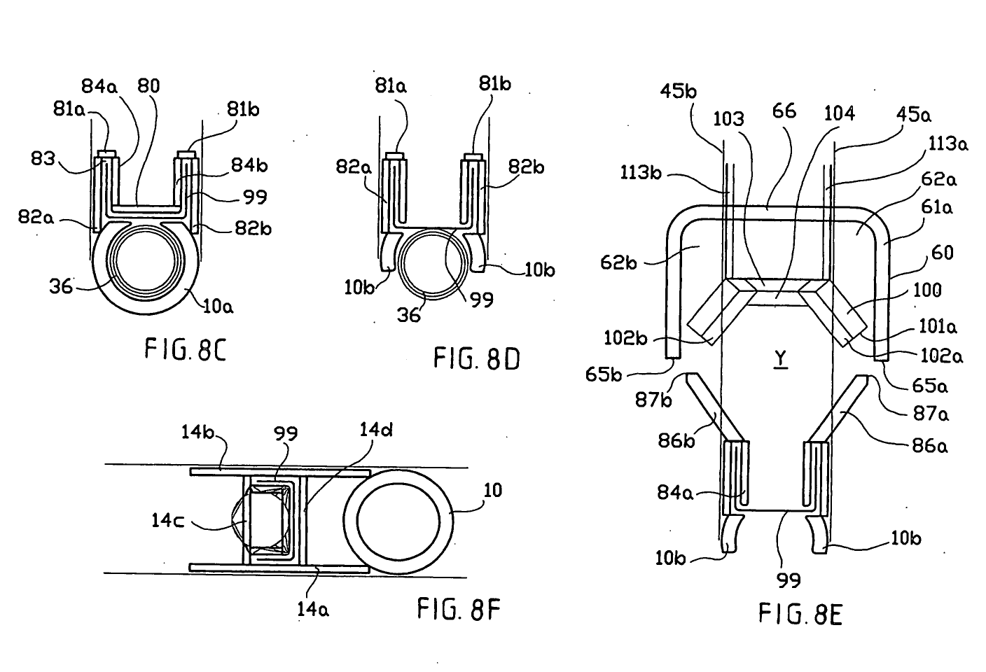

FIG. 8 shows a side view on a plough part of an apparatus according to FIG. 6;

FIGS. 8A-H show several details and cross-sections, partially and schematically, of the plough part of FIG. 8;

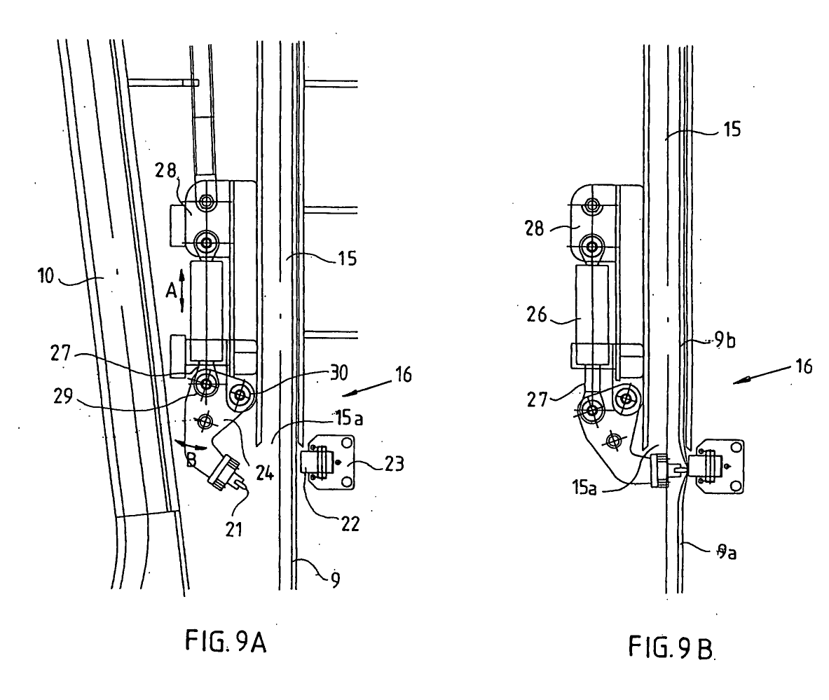

FIGS. 9A and 9B schematically show the portion in the plough part of FIG. 8 with which a drainage ribbon can be cut through; and

FIGS. 10A and 10B illustrate a possible way of connecting the drainage ribbon to the lance of the apparatus of FIG. 6.

FIG. 1 shows a given moment in the installation of a system according to the invention, using an apparatus 1 comprising an excavating machine 40 which is to be discussed below. The machine 40 holds a kings post 2 straight up and provides the necessary power and operation lines. The project was started on the left-hand side in the drawing. The hydraulic machine 40 has moved itself over the ground level 41, underneath which a sand layer 42 is situated. At larger depth a sand layer 44 is situated between relatively weak—for instance clay or loamy—earth strata 43 and 45. In order to be able to carry out a project, such as the construction of a rail road or motorway, at the ground level it is necessary to reinforce the earth stratum 43, which takes place by accelerated consolidation, by letting water present in the layer 43 escape from it. This technique is known per se.

For illustration, FIG. 6 shows an example of the apparatus 1 that can advantageously be used in the installation of the system according to the invention coupled to a hydraulic (excavating) machine 40 in order to form a kind of driving rig, which is common in driving (vertical) drainage ribbons into a ground. The hydraulic machine 40 is supported on ground level 41, and has an arm or boom 110 which is hinged to the machine at 70a. At the outer end, the arm 110 is connected to a U-shaped bracket 12 at hinge 71. A second connection between machine 40 and bracket 12 consisting of a piston/cylinder assembly 4a that extends between hinge 70c on the machine 40 and hinge 73 on the bracket 12. Hinge 73 is located above hinge 71. A further connection is provided between the arm 110 and the machine 40, in order to move the arm 110 up and down by means of hinge 70b, piston/cylinder assembly 4d and hinge 72.

The kings post 2 is connected to both ends of the U-shaped bracket 12 by means of a first connection, consisting of a hinge 75, a piston/cylinder assembly 4c, a hinge 74 and a bracket 3a, located at a distance above the lower end of the post 2, and by means of a second connection, consisting of a hinge 79 and a bracket 3b located at the lower end of the post 2. A lance 5 is supported by the post 2 and can be moved up and down along the post 2 in the directions P by means of means that are known per se and not further shown.

By way of background information, as illustrated in FIGS. 10A,B, the lower end of the lance 5 is connected to an end of drainage ribbon 9, which is unwound from a supply roll (not shown) arranged on the post 2. The lower end of the ribbon 9 is passed in the direction J through a U-bracket 38 fixed to a plate 37, and then the plate 37 is moved against the lower end of the lance 5 in the direction K. When the lance 5 is urged into the ground (direction L), the plate 37, which laterally extends from the lance 5, will bend according to arrows M to form inclined anchoring lips 39. When a length of drainage ribbon has been pressed into a ground to be consolidated by means of the lance 5, the lance 5 is lifted again. Due to the anchoring lips 39, the lower end of ribbon 9 will be held in the ground and stay in its place. The drainage ribbon will be cut through at ground level or above it after letting the lance pass upwards along the kings post, after which the new end of the drainage ribbon is connected again to the lance, for instance by means of an anchor, for a subsequent processing step.

The U-shaped bracket 12 forms a support for a plough 6 too. This plough 6, which will be described in detail, is hinged to the bracket 12 at 77, spaced apart from hinge 79. In addition, the plough 6 is connected to the bracket 12 by means of a piston/cylinder assembly 4b, which is hinged to the bracket 12 at 76 and to the plough 6 at 78, between hinges 77 and 71. Hinge 76 is located between hinges 75 and 73.

The plough 6 has a front edge 7 and a rear side 8. At its lower end, the front edge 7 may be provided with a nose, but it is left out in the figures.

Due to the various hinges 70-79 and the piston/cylinder assemblies 4a-d, the machine 40, the arm or boom 110, the post 2 and the plough 6 may be set at different angles with respect to each other, as illustrated in FIGS. 7A-C. In the upright position of FIG. 7A the piston/cylinder assembly 4d has been extended somewhat, and assembly 4a has been operated to maintain the orientation of bracket 12 as compared to FIG. 6. Two other positions have been indicated in FIG. 7A, that is for the post 2 a lying orientation by swinging the post 2 in direction S, realized by extending assembly 4c, and for the plough 6 a halfway swung back (direction T) orientation, realized by extending assembly 4b, all while maintaining the orientation of bracket 12. In FIG. 7B the post 2 has been left out, and the plough 6 has been swung to a horizontal orientation, while maintaining the orientation of bracket 12.

In FIG. 7C, piston/cylinder assemblies 4a and 4d have been operated to swing the post 2, the bracket 12 and the plough 6 as a unity from the orientation of FIG. 6 into a horizontal, transportation orientation.

Turning now to FIG. 8, at its front edge 7, the plough has a sharp front edge with flanks 7a, 7b. These flanks merge into side plates 113a,b, defining an inner space shielded from the soil and providing strength to the plough 6. In this inner space, the plough 6 is provided with a vertical passage 15, at the lower end of which a schematically indicated ribbon cutter 16 has been arranged, which in an exemplary embodiment is shown in detail in the FIGS. 9A and 9B.

The cutting mechanism 16 shown in FIGS. 9A and 9B is arranged to be active at the lower end of vertical passage 15, near its lower opening 15a. FIG. 9A schematically shows a drainage ribbon 9 vertically extending through the passage 15, at the moment the lance has already been drawn and the drainage ribbon 9 therefore has been inserted into the ground sufficiently deep.

The ribbon cutting mechanism 16 comprises an anvil 22 attached in a holder 23 fixedly arranged on the plough 6, against which anvil a blade 21 can be brought with great force for cutting the drainage ribbon 9. The blade 21 has been attached to a lever 24, which is hingedly attached in the plough 6 at the location of pivot pin 30, and which by means of pin 29 has been attached to the end of a piston rod 27 of cylinder 26, which itself has been attached with the other end to an attachment block 28 fixedly arranged on the plough 6.

When a drainage ribbon 9 has to be cut through, the cylinder 26 is excited with means that are not further shown, so that the piston rod 27 is urged downwards in the direction A. As a result the pin 29 is moved downwards, in which as a result of the hinging attachment of the upper end of the cylinder 26 to the block 28 some deflection to the rear is possible, so that a fluent rotational movement about the pivot pin 30 is possible. Thus the lever 24 is rotated anti-clockwise in the direction B, until the blade 21, as can be seen in FIG. 9B, has separated the drainage ribbon 9 into a portion 9a that is left behind in the ground and a portion 9b that can be arranged at another location. The arrangement shown with vertical operation cylinder 26 and lever 24 for converting a vertical movement into a more or less horizontal cutting movement is efficient as regards occupation of space and power transmission.

At its upper side the plough 6 is provided with attachment eyes 77a and 78a, serving to accommodate hinges 77 and 78, respectively.

At the rear side 8, the plough 6 is provided with a pipe 10, having an entrance 19 at its upper end and a smoothly curved portion 10a at its lower end, which curved portion 10a is cut open in the upper portion of its circumference and ends in portion 10b, where also the lower portion of its circumference has been cut away (notice the cross sections of FIGS. 8C and 8D). The end portion 10b is horizontally oriented and defines exit 20 which is oriented horizontally rearwards.

Parallel to pipe 10, directly rearwards of it, extends a supply for an air-tight sealing foil strip or sheet 99, when the application of such a foil would be needed. The supply comprises a support 90 for a supply roll 98 of a foil strip 99. The strip 99 is guided over idle roll 97 into a downward direction, where it engages about a pipe 91 having a circular cross-section. A small distance below pipe 91 a pipe 93 has been arranged about the pipe 91 to form an annular channel therewith for the foil strip 99 (see FIG. 8B).

As can be seen in FIG. 8A, the lower ends of the circular pipes 91, 93 are received in plate 120 which forms a part of bracket 121 that is fixed to the plough 6. Only the inner pipe 91 continues, and this pipe gradually merges into a U-shaped profile 94 realized at the lower end of bracket 121, just above the curved track 95. As can be seen in FIGS. 8A and 8F, the space around profile 94 is sidewardly bounded by plates 14a,b, to the rear by plate 14c and to the fore by plate 14d (vide also FIG. 8A). The U-shaped profile 94 has a bottom 80 and two side walls 84a,b, as can be seen in the cross-section of FIG. 8C.

The side walls 14a,b are downwardly continued in curved downward extension plates 82a,b in curved track 95 to form a U-shaped channel 83 for the foil strip 99. As can be seen in FIG. 8C, this channel is delimited at its bottom by the pipe 10a, or, at pipe 10b, by the drainage pipe travelling through pipe 10 at the same speed.

Thus, in the downward direction of travelling, the foil 99 is transferred from a more or less circular shape into a U-shape, the legs of the U-shaped foil strip 99 being folded about the bottom 80 and the side walls or legs 84a,b and being laterally confined by the downward extensions 82a,b of the plates 14a,b.

As can be seen in FIGS. 8, 8A, 8E and 8H, the plough 6 is provided with a pair of scraping blades 101, 102, forming part of an inverted U-shaped scraper 100, attached to the lower end of the bracket 121 and defining a horizontal, upwardly confined passage Y (FIG. 8E). The scraper 100 has two inclined scraper blades 101/102a and 101/102b and upper wall 103/104, wherein the blades 102a,b and wall 104 converge towards each other and urge the soil flowing rearwards through the scraper 100 downward.

The scraping blades 101a,b have slanted front edges 105a,b (FIG. 8A, 8H) which project sidewards from the plates 113a,b to cut soil from the walls (45a,b in FIG. 8E) of the trench made by the plough. This cut out soil will then be able to fall on the foil strip 99 that travels just below it. The scraper 100 may be left out in case no foil strip 99 is applied.

Below the scraper 100, the plough 6 is provided with a pair of blades 86a,b extending obliquely upwards and sidewards and having front edges 106a,b that are inclined upwards and rearwards and upper edges 87a,b (FIGS. 8A, 8E and 8G). These blades 86a,b make a cut into the walls of the trench made by the plough in order to make an incision or discontinuity in these walls, so that the stability of the walls below the incision may not be affected by the soil scraper and presser 11 yet to be described, which is active on the soil above the incision.

Reference is made to FIGS. 8 and 8A, in which the soil scraping and pressing and soil filling blades 11 attached to the rear 8 of the plough 6 has been illustrated. The blades 11 are positioned behind the scraper 100 and the blades 87a,b. It regards a substantially inverted U-shaped pressing profile 60, which at its front at the location of 53 is hingingly attached to the plough 6, in particular bracket 121. At its upper side, the profile 60 is provided with a block 50 with stop 51 which abuts against a stop bolt 52 threadingly attached to bracket 121 by means of a pair of nuts 54. By adjusting the nuts 54 the length of projection of bolt 52 can be adjusted, and therewith the angle of orientation of the profile 60 with respect to the plough 6. The profile 60 has two legs 61/62a and 61/62b and an upper wall 66, wherein the upper wall 66 is inclined rearwards and downwards, and the leg portions 62a,b converge to each other, so as to define a narrowing passage or tunnel for the soil. As can be seen in FIGS. 8A and 8E, the edges 64, 65 of the legs 61/62 are downwardly and rearwardly inclined. The level of the edges 65a,b is just below the level of the lower edges of blade legs 101, 102. The wall 66, and therewith the legs 61/62, however, extend laterally beyond the blade legs 101/102 and the blades 86a,b. Moreover, the level of the edges 65a,b is slightly higher than the level of the upper edges 87a,b of the blades 86a,b.

Turning now to the installation of a preferred system according to the invention, the installation is started by rotating (direction T, FIG. 7A) the plough 6 from the position shown left in FIG. 7B to a vertical position, during which movement the plough is able to penetrate the soil. A plough nose may be an aid here. If required a small excavation may be made locally. The plough may have a height of several meters (for example 2 meters or more), in any case sufficient to amply extend into the earth stratum 43.

When the plough 6 has been brought on the right location for arranging a vertical drainage ribbon, the apparatus is operated to press a drainage ribbon 9a in the earth stratum 43 by means of a lance, in the direction E, down to the wanted depth. The lance 5 need not penetrate the sand layer 42 here, but instead easily penetrates the free passage 15 within the plough 6. After the lance 5 has been lifted again and the drainage ribbon 9 has been cut through by the cutting mechanism at about the level of line X in FIG. 1, the machine 40 is driven one step backwards, in which the plough 6 is pulled along in the direction D, while making a trench. During that movement a bendable drainage pipe 36 is supplied from a supply that is not further shown on king post 2, in which the pipe moves through the passage 10, 10a, 10b and exits from the horizontally oriented opening 20 in the direction H (FIG. 8A). By means of a sliding connection 11a according to the invention—further discussed below—the end of the—perforated—drainage pipe 10 is connected to an unperforated, smooth pipe portion 36a, which leads to a deep well pump 31 above ground level, which later on is able to discharge water (and air) in the direction F. The supplying of the drainage pipe 10 at the rear side of the plough 6 is relative: the drainage pipe that is already in the trench remains there, and the plough moves in the direction D.

At the next location where a drainage ribbon has to be arranged, one proceeds as with drainage ribbon 9a and thus the drainage ribbons 9b, 9c, 9d, 9e etc. are arranged stepwise. With all interim movements in the direction D the horizontal drainage pipe 10 is extended stepwise, until—for example—the situation shown in FIG. 1 has been reached. During the movements, the part of the drainage ribbon that extends between the cutting mechanism 16 and the lower side of the plough 6 is horizontally spread on the trench bottom as a result of engaging against the outer bend 10a of the passage 10, and on the thus horizontally turned portion 9a′ (see FIG. 1) the horizontal drainage pipe 10 has come down, as a result of which a direct contact between both drainage elements is possible for quick passing on of water. When the wanted end of the horizontal extension of the pipe 10 has been reached, the pipe can be cut at depth and sealed at the end or connected to a perforated pipe portion that is connected to a second pump, so that in case of larger drainage lengths water can be discharged in two directions.

Alternatively this connection can be realised in a casing of granular material. To that end, simultaneously with either the drainage pipe or with a separate pipe, a granular material is supplied via pipe 10 to a space formed by lower side plough, bend 10a and the vertical ribbon.

In order to let the drainage arrangement be as efficient as possible, use is made of an underpressure system in which according to the invention it is prevented that false air is being drawn in, particularly in the area above the drainage pipe. In order to let the drainage pipe be active as much as possible in downward direction, the contact area with the drainage ribbons, first an incision is made in the trench wall by means of the blades 86a,b, after which the U-blade 60 extends with horizontal portion 66 in those incisions made and soil material below there in the trench wall is cut vertically by the legs 61a, b and after that is removed from the trench wall by the converging legs 62a, b and urged downwards by wall 66. During the movement steps in the direction D of the plough 6, the material is thus pressed and compacted on and around the upper half of the circumference of the horizontal drainage pipe 10 by the pressing blade 60, so that an as it were airtight layer 46 is situated on the pipe 10. The reversed U-shape of blade 60 and the stop 52 here promote the realization of the airtight sealing.

When the work has been completed the plough 6 can be removed from the trench by tilting about hinge 77. alternatively, the assembly of plough 6, bracket 12 and post 2 can be lifted. In that case, the hinged connection of the scraper/presser 11/60 at 53 permits the scraper/presser to rotate towards a more vertical orientation in which the lifting movement is facilitated. In addition, by such an orientation it is avoided that the walls of the trench are severely damaged, which would otherwise result in local collapse of these walls and loosened soil falling on the drain, due to which a leakage path might be realized.

In case the type of soil is less cohesive or substantially granular, the foil 99 can be used to provide an air tight seal on the pipe 10. Here, the scraper 100 and the parts for the supply of the foil strip 99 are used, the strip 99 being supplied at the same speed as the drainage pipe 10 in the direction I and H, respectively (FIGS. 8 and 8A). The scraper cuts the soil from the trench walls, crumbles it and urges it downwards to let it fall on the foil strip 99 which is then already more or less horizontal. Thus it is ensured that the strip has a proper position on the upper side of the drainage pipe before the pressing and filling blade 60 becomes active in the area concerned. The foil 99 used can be a composite one, such as a sandwich foil of an upper layer and a lower layer of polypropylene for strength, and an air tight foil in between these layers.

FIG. 2 shows a detail of a system 200 according to the invention after installation according to FIG. 1, in which a central soil area 201 is indicated, that does not need to be consolidated, as well as on either side of it soil areas 43a and 43b that need to be consolidated indeed. A pump 31 has been placed on the ground level 141 of soil area 201 that is not to be consolidated. The pump 31 has an exit 31a for discharge of water from the soil areas 43a and 43b to a discharge that is not further shown.

Several entrances 37a,b have been provided on pump 31, to which entrances pump or suction lines 36a,b have been connected.

From the ground level 141, the pump lines 36a,b extend in a more or less bent manner into the soil of the soil area 201, in order to at some depth by means of slide connections 11a, 11b connect to the horizontal drainage lines 10a,b.

The horizontal drainage lines 10a,b are connected for drainage to turned upper ends of drainage ribbons 9a, 9b that are known per se and which extend vertically into the soil areas 43a, 43b.

The drainage lines 10a,b with drainage ribbons 9a,b (which are spaced from each other) form drainage screens in the soil areas 43a, 43b, in order to consolidate them by drainage of the soil present in said soil areas. At the location of fictive border areas U the areas 43a, 43b change into the central soil area 201.

As depicted in FIG. 1 and shown more clearly in FIG. 2, a slide connection 11a has been provided between the lower end of the pump line 36a and the horizontal drainage line 10a, which slide connection 11a is situated at the level of the imaginary separation area U, that is situated near the drainage ribbon 9a, which, as seen in the drawing, is situated most to the left.

As shown in FIG. 3 the end 212a of the pump line 36a extends into the, as seen in the drawing, left-hand end of the drainage line 10a. An overlap S is formed here.

After some time of dewatering (N, O, P, F), the ground level 141 will have dropped in the direction Q, and the drainage line 10a will also have dropped to the position indicated by dashes. During said drop a part of the overlap S of the end of the pump line 36a has been able to slide out of the left end of the drainage line 10a, without the rest of the suction line 36a or the rest of the drainage line 10a being troubled by it. In fact the active part of the suction line 36a has been lengthened with a portion of end 212a.

The suction line 36a here remains in its place in the soil area 43a and is not subjected to particular tensile stresses.

The suction line 36a can be manufactured of a polythene having a smooth outer surface and is flexible though strong enough to retain its cross-sectional shape under the soil pressure. The drainage line 10a may in the known manner be a ribbed drainage pipe, which as it were is anchored into the soil of the soil area 43a,b.

A first example of the slide connection 11a (slide connection 11b can be similar) is shown in FIG. 4. At the end of the ribbed drainage pipe 10a an end-piece 213a is coupled by means of snap socket 214a provided with snap lips 229 engaging in the valleys between the ribs. Within the end-piece 213a an adapter pipe piece 215a is clamped in, which has a widened pipe portion forming a closing partition 216a and a narrowed pipe portion 217a formed integrally therewith. By means of snap socket 214a the end-piece 213a can simply be snapped onto the end of the drainage pipe 10a.

The pipe portion 217a then extends from the end-piece 213a into the drainage pipe 10a. At the end of pipe portion 217a a clamping coupling 218a has been attached which is thus shielded from the soil and thus is able to work reliably. The clamping coupling 218a comprises a sleeve 219a having a first portion 220a and a second portion 221a, separated from each other by a ring shoulder 226a. The first sleeve portion 220a fits onto the pipe portion 217a and in circumferential sense is interrupted to form conical threaded lips 223a. A clamping ring 222a extends over the lips 223a and has an inner surface which is correspondingly conical and provided with an internal screw thread, which can cooperate with screw thread on lips 223a. In this way the sleeve 219a can be secured onto the end of the pipe portion 217a.

At the inner circumference the sleeve portion 221a is provided with sealings 224a, which in a firm sealing yet sliding manner engage the smooth outer surface of the flexible suction line 36a. Likewise the—non threaded—inner circumference of clamping ring 222a is provided with a sealing ring 227a.

At the outer surface of the suction line 36a a stop 225a has furthermore been provided, for limiting an inward motion of suction line 36a in the discharge end 213a. In FIG. 3 is can be seen that the suction line 36a with receiving end portion 212a extends within the discharge end (lengthened with end-piece 213a) of the drainage pipe 10a in order to form overlap S. Said overlap equals the calculated settlement with some reserve.

When during the operation of the system the soil area 43a drops, the slide connection 11a will make the elongation of a part of the pipe end 212a from the slide coupling possible. The smooth surface of the suction line 36a and the presence of the sealing rings 224a, 227a make a supple slide possible, which is soil and airtight.

FIG. 5 shows a preferred, alternative sliding connection 311a according to the invention, in which at the end of the ribbed drainage pipe 10a an end-piece 313a is coupled by means of snap socket 314a provided with snap lips 329 engaging in the valleys between the ribs. Within the end-piece 313a a cross-partition 316a is located separating the inner space of the end-piece 313a into two spaces. A pipe piece 315a is attached to or formed as a unity with the cross-partition 316a. By means of snap socket 314a and lips 329 the end-piece 313a can simply be snapped onto the end of the drainage pipe 10a.

On pipe piece or stub 315a, a clamping ring 322a with conical outer surface(s) 332a has been placed, which ring 322a is interrupted in circumferential direction. A nut 323a provided with an internal thread 330a and an—in axial direction subsequent—conical inner surface 331a is arranged over the ring 322a, so that the conical surfaces 331a and 332a engage each other.

In addition, a sleeve 319a having a widened portion 320a and a narrowed portion 321a, separated from each other by a ring shoulder 326a has been placed on the pipe piece 315a. The widened sleeve portion 320a fits onto the pipe portion 317a and is provided with sealing rings 327a sealingly engaging the outer surface of portion 317a for preventing water to flow between pipe portion 317a and widened sleeve portion 320a. The clamping ring 322a axially abuts sleeve portion 320a. Likewise, the narrowed sleeve portion 321a is provided with a sealing ring 324a sealingly engaging smooth pump pipe 36a—yet allowing a sliding movement of pipe or line 36a with respect to portion 315a and threwith with respect to drainage pipe 10a—.

By rotating the nut 323a it is threaded onto the widened portion 320a while contracting the clamping 322a, thus generating a clamping connection—axially fixed—between the sleeve 319a and the end piece 313a.

The sliding connection 311a is shielded off from the soil by the end piece 313a so as to ensure a proper functioning.

At the outer surface of the suction line 36a a stop 325a has furthermore been provided, for limiting an inward motion of suction line 36a in the discharge end 313a. In FIG. 4 is can be seen that the suction line 36a with receiving end portion 312a extends within the discharge end (lengthened with end-piece 313a) of the drainage pipe 9a in order to form overlap S. Said overlap equals the calculated settlement with some reserve.

When making the trench the plough can be hindered by high density types of soil, or by obstacles of a natural or artificial nature. In order to remove or minimize that hinder the plough can be equipped with means known per se for breaking off the cohesion of the soil and/or obstacles or displacing them. In one embodiment the plough at its front edge 7 is provided with one or several blades that are vertically movable over the entire height of the cut surface. When necessary these blades make an upward and downward movement.

Alternatively for making the trench, the trench-making device can be provided with a ground cutter in the portion in front of a vertical passage of the lance/the ribbon. It strongly resembles a chain saw and may consist of an endless chain which may or may not be provided with teeth and/or scrapers. A chain here runs in the centre of the device about a drive wheel at the upper side of the device to a turn wheel at the lower side of the device. The shafts of the chain wheels are perpendicular to the direction of travel of the device whereas the chain runs in the plane of the direction of movement of the device. Here the device is furthermore provided with the means described earlier on for supplying the pipe and possibly the U-shaped soil closing blades.

The movement of the chain may take place in continuous rotating movement or in an up and downwardly oscillating movement. In a special embodiment several chains may run side by side possibly having an opposing direction of movement.

Alternatively the plough can be provided with one or several vibrating mechanisms to let the plough make a pulsating movement in the propelling movement as well as transverse to it.

It is noted that the systems and methods discussed can also be used from a pontoon on a subaqueous soil.

In addition, it is noted that the systems and methods discussed above can be used in the exploitation of minerals, such as gold, in particular under circumstances in which the mineral-containing slurry resulting from mining activities is deposited as a landfill in a compartment. The above-described apparatus and method can be used for withdrawing water from the landfill, whereafter the minerals present in the water can easily be separated from the water that has been withdrawn from the landfill. The sliding connection between the drainage line and the pump line according to the invention permits the lines to smoothly follow the movement of settlement of the soil area from which water is being withdrawn.

1. System for withdrawing liquid, in particular water, from a soil area, such as for consolidating it, comprising a series of spaced apart drains extending downwardly, in particular substantially vertically, in the soil and a substantially horizontally extending drainage line, which is arranged in the soil for receipt of the soil fluid passed through the downwardly extending drains and which in a transitional area in a border area of the soil area to be treated, such as to be consolidated, changes into a pump line which leads to a pump positioned outside of the soil area to be treated, an oversize of line length being provided in the transitional area prior to making the system operational, the oversize being designed as a slide connection with an overlap between two line ends that are inserted into each other.

2. System according to claim 1, the oversize having at least a length which at a minimum is adjusted to the expected settlement.

3. System according to claim 1, the transitional area being situated near the outermost downwardly extending drains.

4. System according to claim 1, the line ends being formed by a discharge end of the drainage line and a receiving end of the pump line, which at the location of the slide connection can be slid into each other and forming an overlap at that location.

5. System according to claim 4, the receiving end of the pump line being slidably accommodated in the discharge end of the drainage line.

6. System according to claim 4, the slide connection comprising a sleeve part and a clamping part for securing the discharge end of the drainage line to the sleeve part by clamping about it, the sleeve part slidably holding the receiving end of the pump line.

7. System according to claim 6, a sealing being arranged between the sleeve part and the receiving end of the pump line.

8. System according to claim 1, the slide connection being provided with a limiter which is active in the direction of mutual approach of the discharge end of the drainage line and the receiving end of the pump line.

9. System according to claim 1, the discharge end being detachably attached to the end of a drainage line, such as by means of a snap connection.

10. System according to claim 9, the slide connection being accommodated within a sleeve that is part of the discharge end.

11. System according to claim 1, wherein the downwardly extending drains are elongated and spaced from each other.

12. System according to claim 11, wherein the downwardly extending drains are formed by drainage strips/ribbons.

13. System according to claim 1, wherein the horizontal extending drainage line is covered by an air sealing layer.

14. Assembly for withdrawing liquid, in particular water, from a soil area for consolidating it, comprising a number of systems according to claim 1, which each are connected to a central pump with their own pump line.

15. Assembly for withdrawing liquid, in particular water, from a soil area for removing substances from the soil area, comprising a number of systems according to claim 1, which each are connected to a central pump with their own pump line.

16. System for withdrawing liquid, in particular water from a soil area, such as for consolidating it, comprising a series of spaced apart drains extending downwardly, in particular substantially vertically, in the soil and a substantially horizontally extending drainage line, which is arranged in the soil for receipt of the soil fluid passed through the downwardly extending drains and which in a transitional area in a border area of the soil area to be treated, such as to be consolidated, changes into a pump line which leads to a pump positioned outside of the soil area to be treated, an oversize of line length being provided in the transitional area prior to making the system operational.

17. System according to claim 16, the oversize being designed as a slide connection with an overlap between two line ends that are inserted into each other.
